(19) United States
(12) Patent Application Publication
(10) Pub. No.: US 2007/0295135 A1
(43) Pub. Date: Dec. 27, 2007

(54) Worm and motor apparatus having the same

(75) Inventor: Koji Kidowaki, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD., Kosai-city (JP)

(21) Appl. No.: 11/808,582

(22) Filed: Jun. 12, 2007

(30) Foreign Application Priority Data
Jun. 21, 2006 (JP) 2006-171244

(51) Int. Cl. F16H 1/16; H02K 7/116

(52) U.S. Cl. 74/425

(57) ABSTRACT

A pitch radius of a worm tooth decreases toward an axial center of a worm. A first side flank of the tooth is defined such that a normal line to the first side flank is angled relative to an axial line in a longitudinal cross section of the worm. The normal line is normal to the first side flank at a contact point between a pitch line of the worm tooth and the first side flank. The axial line is parallel to a central axis of the worm and extends through the contact point. An angle between the normal line and the axial line at the first side flank is generally constant throughout an entire axial extent of the worm.

### CROSS REFERENCE TO RELATED APPLICATION

This application is based on and incorporates herein by reference Japanese Patent Application No. 2006-171244 filed on Jun. 21, 2006.

### BACKGROUND OF THE INVENTION

1. Field of the Invention

The present invention relates to a worm and a motor apparatus having the same.

2. Description of Related Art

For example, a motor apparatus, such as a wiper motor or a power window motor, includes a motor unit and a speed reducer. The speed reducer reduces a rotational speed of rotation transmitted from the motor unit. The speed reducer has a worm gear, which includes a worm and a worm wheel.

FIG. 7 shows one previously proposed worm gear, in which a worm wheel 123 is meshed with a cylindrical worm 131 that has a generally constant deddendum radius R1 along a central axis C1. In the cylindrical worm 131 of FIG. 7, a pressure angle of each flank of a worm tooth 134, which protrudes from a bottom land of the worm 131, is set to about 10 degrees. The cylindrical worm 131 is substantially meshed with the worm wheel 123 in a range A1. In this instance, the number of effective teeth is five (see the number of effective teeth of the worm wheel 123 in the range A1). Furthermore, each direction of protrusion (hereinafter, referred to as a tip direction) of the worm tooth 134 is generally perpendicular to the axis C1 (see single-pointed arrows in FIG. 7).

In the above-described type of worm gear, in order to increase the number of effective teeth between the worm and the worm wheel and to increase the transmittable load between the worm and the worm wheel, an hourglass-shaped worm 231 of FIG. 8 is often used.

An addendum line (a dotted line in FIG. 8) of the hourglass-shaped worm 231 is generally arcuately configured, so that an addendum radius of the worm 231 increases from an axial center area of the worm 231 (i.e., a throat of the worm 231 where a deddendum radius R2 is minimum) in a direction away from the center area along a central axis C2. In FIG. 8, the pressure angle of the worm 234 is set to about 10 degrees. The hourglass-shaped worm 231 can be formed with a form rolling die in a form rolling process (see, for example, Japanese Unexamined Patent Publication No. 2006-21247, which corresponds to US 2005/0272354 A1). Alternatively, the hourglass-shaped worm 231 can be formed with a pinion cutter in a gear cutting process (see, for example, Japanese Unexamined Patent Publication No. 2001-252823).

With respect to the hourglass-shaped worm 231, there is measured an angle of a normal line, which is normal to a flank of the worm tooth 234, relative to an axial line, which passes a base of the normal line and is parallel to the axis C2. The measured angle approaches zero degree as an axial distance from the center area of the worm 231 along the axis C2 increases. Here, in a case where the pressure angle of the worm tooth 234 is equal to or greater than 14 degrees, a possibility of having a negative value for the angle of the normal line of the flank, which faces the center area, with respect to the axial line parallel to the axis C2 is relatively small at each of the axial ends of the hourglass-shaped worm 231.

In general, in a case of a worm shaft having a relatively long hourglass-shaped worm, the following disadvantage may be encountered. That is, in order to limit warping of the worm shaft at the time of applying a load to the worm shaft and to maintain stable engagement between the worm and the worm wheel by limiting a center distance between the worm and the worm wheel, the pressure angle of the worm tooth of the worm may be set to about ten degrees like in the case of FIG. 8. However, in such a case, an angle of a normal line, which is normal to a flank of a worm tooth facing a center area of the worm, relative to the axial line parallel to the axis of the worm may possibly exceed zero degree and becomes a negative value at each of axial ends of the worm.

That is, when the pressure angle of the worm tooth is set to the relatively small value, the flank at the respective ends of the hourglass-shaped worm forms an undercut. Thus, it is difficult to form the worm tooth on a surface of a hourglass-shaped material through use of, for example, the form rolling die. Therefore, at the time of designing the hourglass-shaped worm, the pressure angle needs to be set in an appropriate range, which will not cause the formation of the undercut, or the axial length of the hourglass-shaped worm needs to be appropriately reduced.

In FIG. 8, the pressure angle is set to about ten degrees, and the length of the worm in the direction of the axis C2 is set to be relatively short. In this instance, the worm tooth 234 protrudes toward a center of the arc (not shown) as indicated by single-headed arrows in FIG. 8. In FIG. 8, the hourglass-shaped worm 231 is meshed with the worm wheel 123 in a range A2, and the number of effective teeth in engagement between the hour-glass shaped worm 231 and the worm wheel 123 is about four. When the length of the worm 231 is reduced, the number of effective teeth in engagement between the worm 231 and the worm wheel 123 becomes disadvantageously smaller in comparison to the case of the cylindrical worm 131.

### SUMMARY OF THE INVENTION

The present invention addresses the above disadvantage. According to the present embodiment, there is provided a worm, which includes a bottom land and a helical worm tooth. The worm tooth protrudes from the bottom land and has a first side flank and a second side flank, which are opposed to each other in an axial direction of the worm. A pitch radius of the worm tooth decreases toward an axial center of the worm at least in a part between one axial end of the worm and the axial center of the worm. The first side flank is defined such that a first side normal line to the first side flank is angled relative to a first contact side axial line in a longitudinal cross section of the worm. The first side normal line is normal to the first side flank at a first side contact point between a pitch line of the worm tooth and the first side flank. The first contact side axial line is parallel to a central axis of the worm and extends through the first side contact point. A first side angle between the first side normal line and the first contact side axial line is generally constant throughout an entire axial extent of the worm.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross sectional view of a motor apparatus according to an embodiment of the present invention;

FIG. 2 is descriptive partial side view of a worm shaft shown in FIG. 1;

FIG. 3 is descriptive fragmented cross sectional view of the worm shaft and a worm wheel shown in FIG. 1;

FIGS. 4A and 4B are descriptive partial cross sectional views of a worm tooth of the worm shaft shown in FIG. 1;

FIG. 5 is a schematic cross sectional view showing a modification of the worm shaft;

FIG. 6 is a schematic cross sectional view showing another modification of the worm shaft;

FIG. 7 is a schematic cross sectional view showing a meshed state between a cylindrical worm shaft and a worm wheel in a related art; and

FIG. 8 is a schematic cross sectional view showing a meshed state between an hourglass-shaped worm shaft and a worm wheel in another related art.

### DETAILED DESCRIPTION OF THE INVENTION

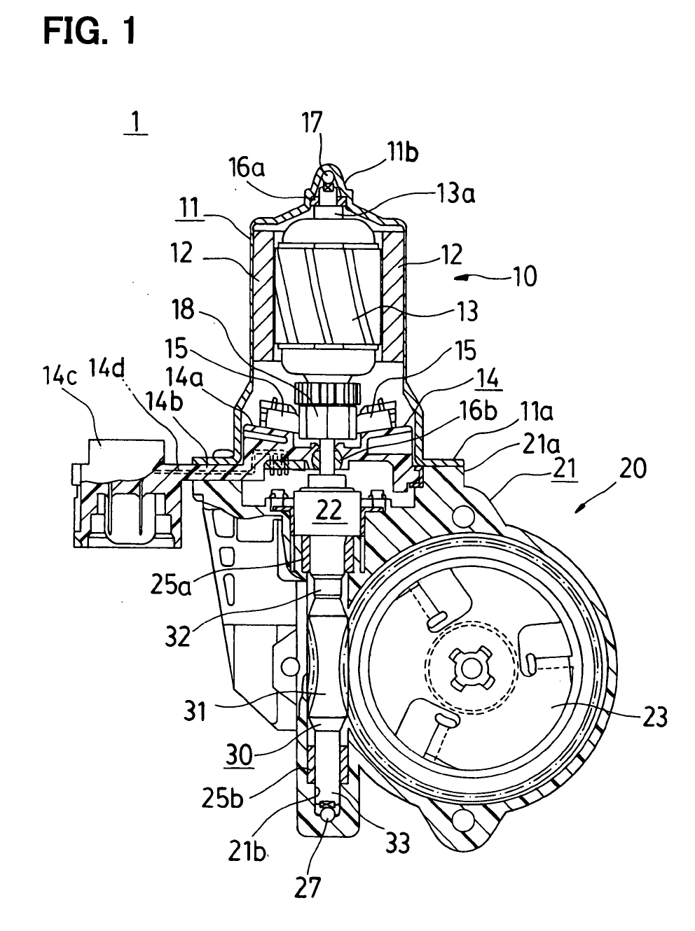

An embodiment of the present invention will be described with reference to FIGS. 1 to 4B.

With reference to FIG. 1, a motor apparatus (a power window motor) 1 of the present embodiment is used in a power window system installed in a vehicle door and includes a motor unit 10 and a speed reducer 20.

The motor unit 10 includes a yoke housing 11, two magnets 12, an armature 13, a brush holder 14 and two brushes 15. The speed reducer 20 includes a gear housing 21, a clutch 22, a worm wheel 23 and a worm shaft 30.

The yoke housing 11 is formed as a generally flattened cup-shaped body. The magnets 12, each of which has a generally arcuate cross section, are fixed to an inner peripheral surface of the yoke housing 11 such that the magnets 12 are opposed to each other. A shaft receiving recess 11b bulges axially outward at a bottom center of the yoke housing 11. A bearing 16a and a ball 17 are arranged in the shaft receiving recess 11b. The bearing 16a rotatably supports one axial end of a rotatable shaft 13a of the armature 13. The other end of the rotatable shaft 13a is rotatably supported by a bearing 16b, which is provided to the brush holder 14. The ball 17 engages the one end of the rotatable shaft 13a to support a thrust load, which is applied to the armature 13.

An opening 11a of the yoke housing 11 is flanged and is fixed to an opening 21a of the gear housing 21 with screws through the brush holder 14. In this way, the brush holder 14 is clamped between the opening 11a of the yoke housing 11 and the opening 21a of the gear housing 21.

The brush holder 14 includes a holder main body 14a, an extension 14b and an electrical power feeder 14c, which are formed integrally.

The holder main body 14a is substantially entirely received in the opening 11a of the yoke housing 11. The holder main body 14a slidably holds the brushes 15 in such a manner that the brushes 15 are radially inwardly urged toward the rotatable shaft 13a, and thereby distal ends of the brushes 15 are slidably engaged with a commutator 18, which is fixed to the rotatable shaft 13a. The bearing 16b is installed to a center portion of the holder main body 14a. A distal end side portion of the rotatable shaft 13a is rotatably supported by the bearing 16b and protrudes from the bearing 16b toward the speed reducer 20.

The extension 14b extends outwardly from the holder main body 14a in a radial direction of the rotatable shaft 13a and is clamped between the yoke housing 11 and the gear housing 21 in such a manner that a portion of the extension 14b projects outwardly from the yoke housing 11 and the gear hosing 21.

The electrical power feeder 14 is provided to an outer end of the extension 14b and is connectable with a vehicle side connector (not shown). Multiple electrical terminals 14d are insert molded into the brush holder 14 in such a manner that one ends of the electrical terminals 14d project into the electrical power feeder 14c. The other ends of the electrical terminals 14d are electrically connected to various undepicted sensors (e.g., a rotation sensor) of the motor apparatus 1 and also to the brushes 15. When the vehicle side connector is connected to the electrical power feeder 14c, an electric power as well as various electrical signals can be conducted through the electrical terminals 14d.

The gear housing 21 is made of resin and receives the clutch 22, the worm wheel 23 and the worm shaft 30. As discussed above, the gear hosing 21 has the opening 21a, which can close the opening 11a of the yoke housing 11.

The worm shaft 30 includes a worm 31 and shaft sections 32, 33. The worm 31 meshes with the worm wheel 23, and the shaft sections 32, 33 axially extend from opposed ends, respectively, of the worm 31. The worm shaft 30 is rotatably supported by bearings 25a, 25b, which are provided at predetermined locations, respectively, in the gear housing 21. The bearings 25a, 25b rotatably support the shaft sections 32, 33, respectively.

The gear housing 21 has a shaft receiving recess 21b, which holds a distal end portion of the worm shaft 30. A ball 27 is received in the shaft receiving recess 21b and is engaged with an end of the shaft section 33 to support a thrust load of the worm shaft 30.

The shaft section 32 of the worm shaft 30 and the rotatable shaft 13a of the motor unit 10 are coupled together through the clutch 22.

The clutch 22 is a one-way clutch, which transmits a drive force from the rotatable shaft 13a to the worm shaft 30 but does not transmit a drive force from the worm shaft 30 to the rotatable shaft 13a. That is, the clutch 22 is provided to limit unintentional rotation of the motor 10 caused by an external force applied from a load side.

The worm wheel 23 is connected to an output shaft, which extends in a direction perpendicular to a longitudinal direction of the worm shaft 30. This output shaft is connected to a well known X-arm type regulator (not shown), which raises and lowers a window glass of the vehicle door.

In the present embodiment, although the rotatable shaft 13a and the worm shaft 30 are coupled together through the clutch 22, the clutch 22 may be eliminated in some cases, and the rotatable shaft 13a and the worm shaft 30 may be formed integrally.

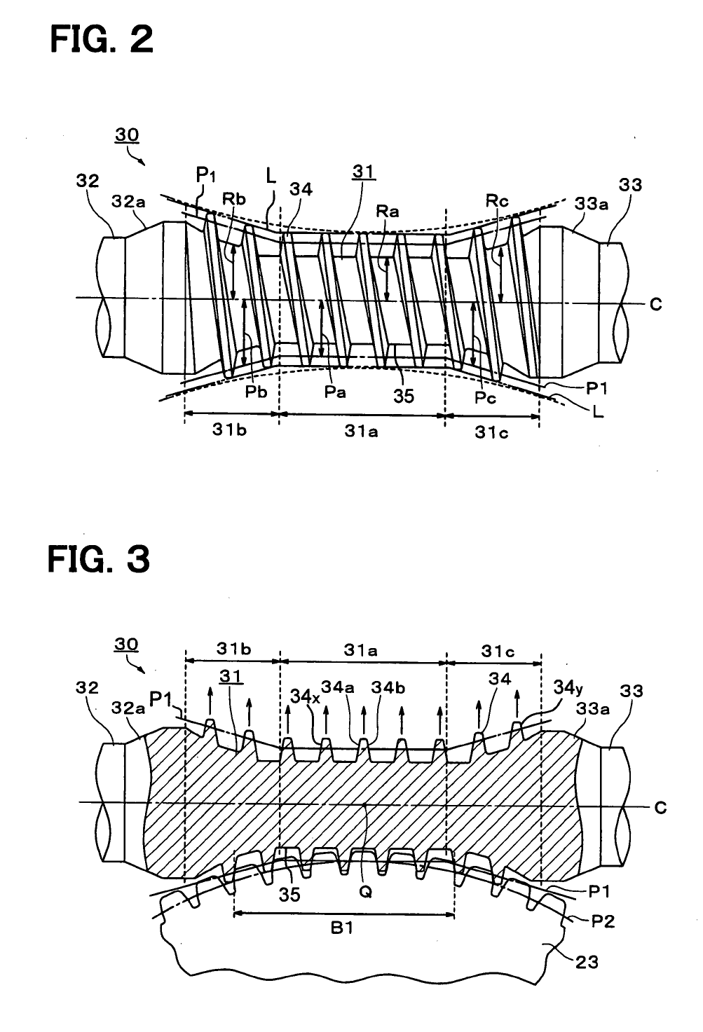

Next, the worm shaft 30 of the present embodiment will be described in detail with reference to FIGS. 2 and 3.

The worm shaft 30 of the present embodiment is produced through a form rolling process of a metal shaft material, which has a predetermined shape. A helical worm tooth 34 is formed in the worm 31 of the worm shaft 30 as a single helical tooth and protrudes from a bottom land 35 of the worm 31.

As shown in FIG. 2, the worm 31 of the present embodiment includes a cylindrical worm section 31a and two tapered worm sections 31b, 31c. The tapered worm sections 31b, 31c are provided to opposed ends, respectively, of the cylindrical worm section 31a. In the cylindrical worm section 31a, a deddendum radius Ra is generally constant along a central axis C, and a pitch radius Pa is also generally constant along the axis C. Here, the deddendum radius Ra means a radius of a circle that circumferentially extends along the bottom land 35, and the pitch radius Pa means a radius of a circle that circumferentially extends along each corresponding contact point of the tooth 34, which contacts with the corresponding tooth of the worm wheel 23. Therefore, the cylindrical worm section 31a forms an imaginary cylindrical surface along the deddendum circles or the pitch circles thereof.

In each of the tapered worm sections 31b, 31c, a deddendum radius Rb, Rc shows a linear increase (a linear functional increase) in a direction away from the cylindrical worm section 31a along the axis C, and a pitch radius Pb, Pc also shows a linear increase (a linear functional increase) in the direction away from the cylindrical worm section 31a along the axis C. A degree of increase in the radius of the respective tapered worm sections 31b, 31c (more specifically, a degree of increase in the deddendum radius Rb, Rc as well as a degree of increase in the pitch radius Pb, Pc of the respective tapered worm sections 31b, 31c) is generally constant in the axial direction. In the case where the degree of increase in the deddendum radius Rb, Rc as well as the degree of increase in the pitch radius Pb, Pc are generally constant, and the worm 31 is formed through the form rolling process, the form rolling die, which is used to form the worm 31, can be relatively easily produced.

In FIG. 2, each of upper and lower dot-dot-dash lines indicates a corresponding addendum line (a top land line) L, which is defined by a top land (an addendum radius) of the worm tooth 34. The addendum line L forms a straight line, which is generally parallel to the axis C, in the cylindrical worm section 31a and forms a straight line, which is angled at a predetermined angle relative to the axis C, in the respective tapered worm sections 31b, 31c. Thereby, the entire addendum line L forms a slightly trapezoidal configuration or a generally arcuate curve.

Furthermore, in FIG. 2, each of upper and lower dot-dash lines shows a corresponding pitch line P1 of the tooth 34. The pitch line P1 is defined by the pitch radii Pa, Pb, Pc. In FIG. 3, the upper pitch line P1 interconnects upper radial end points of the pitch circles, which are defined by the pitch radii Pa, Pb, Pc, and the lower pitch line P1 interconnects lower radial end points of the pitch circles. As described above, the pitch radius of the worm 31 of the present embodiment varies along the length of the worm 31 in the direction of the axis C.

An axially outer end (an end opposite from the cylindrical worm section 31a) of each of the tapered worm sections 31b, 31c is connected to an end of the adjacent shaft section 32, 33. In the present embodiment, an outer diameter of a main body of each of the shaft sections 32, 33 is set to be smaller than an outer diameter of the outer end of the adjacent tapered worm section 31b, 31c. The main body of each shaft section 32, 33 is connected to the adjacent tapered worm section 31b, 31c through a tapered part 32a, 33a, which has an increasing diameter that increases toward the outer end of the adjacent tapered worm section 31b, 31c.

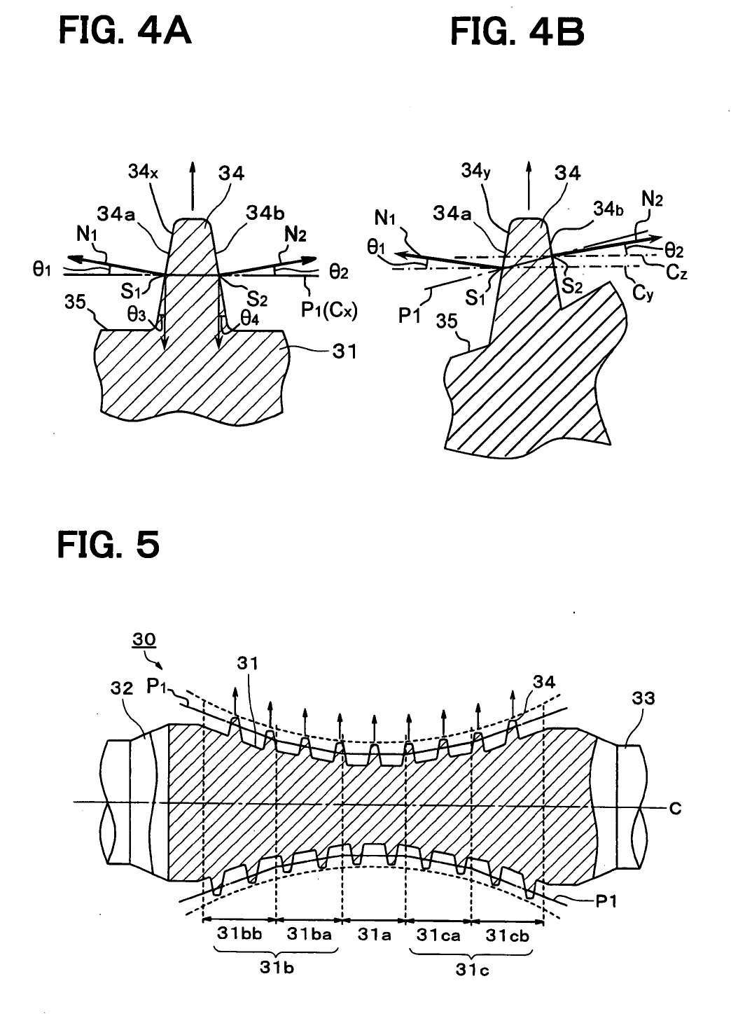

In the present embodiment, pressure angles θ3, θ4 the worm tooth 34 (see FIG. 4A) are generally the same along the length of the worm 31 regardless of a position of the worm tooth 34 along the entire length of the worm 31 and are set to be about 10 degrees, which is a relatively small value. Furthermore, as shown in FIG. 3, tip directions (indicated by single-pointed arrows in FIG. 3) of the worm tooth 34 differ from those of ordinary hourglass-shaped worms and are generally perpendicular to the axis C regardless of a position of the worm tooth 34 along the length of the worm 31. The tip direction referrers to a protruding direction of the worm tooth 34 relative to the axis C in the longitudinal cross section of the worm 31 (see the arrows in FIG. 3). In FIG. 3, a dot-dash line P2 indicates a pitch circle of the worm wheel 23.

FIG. 4A shows the enlarged partial cross sectional view of the worm tooth 34 at a portion 34x in the cylindrical worm section 31a in FIG. 3, and FIG. 4B shows the enlarged partial cross sectional view of the worm tooth 34 at a portion 34y in the tapered worm section 31c in FIG. 3. As shown in FIG. 4A, the worm tooth 34 at the portion 34x is generally symmetrical about a left-to-right center of the worm tooth 34. Each of first and second side flanks (left and right flanks) 34a, 34b is depicted to have a generally flat surface. Alternatively, each of the flanks 34a, 34b may have a curved surface, such as an involute surface.

Furthermore, in the cross section shown in FIGS. 4A and 4B, each of first side and second side angles θ1, θ2 is defined between a corresponding normal line N1, N2 and a corresponding axial line Cx, Cy, Cz in the longitudinal cross section of the worm 31. The normal line N1, N2 is perpendicular to the corresponding flank 34a, 34b at a contact point S1, S2, which is between the pitch line P1 of the worm tooth 34 and the flank 34a, 34b. The axial line Cx, Cy, Cz is parallel to the central axis C of the worm 31 and extends through the corresponding contact point S1, S2. In the case where each flank 34a, 34b is formed to have the curved surface, the normal line N1, N2 may be perpendicular to a tangent at the corresponding contact point S1, S2 on the corresponding curved flank.

In the present embodiment, as discussed above, the first side angle θ1 and the second side angle θ2 are generally the same along the entire axial extent of the worm 31, so that the tip directions indicated by the single-pointed arrows in FIG. 3 become generally perpendicular to the axis C of the worm 31 throughout the entire axial extent of the worm 31. However, in the present embodiment, it is only required that only one of the first and second side angles θ1, θ2 is generally constant throughout the entire axial extent of the worm 31, and the first side angle θ1 and the second side angle θ2 may differ from each other depending on the intended use of the worm 31. For instance, if the motor apparatus 1 rotates in both the normal direction and the reverse direction, it is desirable to have the same angle for each of the first and second side angles θ1, θ2 throughout the entire axial extent of the worm 31. Each of the first and second side angles θ1, θ2 may be greater than zero degree and less than 14 degrees. In the present embodiment, each of the first and second side angles θ1, θ2 is set to be about 10 degrees. Thus, in the longitudinal cross section of the worm 31, the first side flanks (left flanks) 34a of the worm tooth 34 are generally parallel to each other along the direction of the axis C, and the second side flanks (right flanks) 34b of the worm tooth 34 are also generally parallel to each other along the direction of the axis C.

Therefore, in the longitudinal cross section of the worm 31, each flank 34a, 34b of the worm tooth 34 does not form an undercut even at a remote location, which is remote from an axial center Q (see FIG. 3) of the worm 31 in the axial direction and has the relatively small pressure angle. Thus, it is possible to set a relatively long length of the worm 31 in the direction of the axis C. In the present embodiment, by setting the relatively long length of the worm 31 in the direction of the axis C, the number of effective teeth in engagement between the worm 31 and the worm wheel 23 can be increased to about six (see a range B1 in FIG. 3), so that a transmittable load can be increased.

Furthermore, the respective pressure angles θ3, θ4 of the worm 31 are set to the relatively small value, so that warping of the worm shaft 30 can be effectively limited.

Furthermore, in the present embodiment, the flanks 34a, 34b of the worm tooth 34 do not become the undercut, so that the worm tooth 34 can be relatively easily formed with the form rolling die through the form rolling process. In this case, as discussed above, the metal shaft material is formed into the predetermined shape and is thereafter processed with the form rolling die through the form rolling process. At that time, the form rolling die is engaged with the surface of the metal shaft material while maintaining an angle of the form rolling die in the direction of the axis C without tilting the form rolling die relative to the axis C.

In the case of the worm 31 of the present embodiment, during the normal operation, the number of effective teeth in engagement between the worm 31 and the worm wheel 23 is two or three, and the cylindrical worm section 31a is mainly meshed with the worm wheel 23. Furthermore, at the time of motor locking, the tapered worm section 31b or the tapered worm section 31c is also meshed with the worm wheel 23 to maintain the required gear strength. For this purpose, a clearance between respective adjacent two teeth is adjusted by a degree of tapering (the degree of decrease in the radius toward the axial center or the degree of increase in the radius toward the axial outer end) of the respective tapered worm sections 31b, 31c.

The above embodiment may be modified as follows. In the following description, components similar to those of the above embodiment will be indicated by the same numerals and will not be described further.

In the worm 31 of the above embodiment, each tapered worm section 31b, 31c is formed as a single tapered section, which has a single degree of increase in the pitch radius thereof toward the axial outer end (or a single degree of decrease in the pitch radius thereof toward the axial center), on each of the opposed sides of the cylindrical worm section 31a. However, the present invention is not limited to this. For instance, each tapered worm section 31b, 31c may be modified to have multiple tapered sections, each of which has different degrees of increase in the pitch radius thereof toward the axial outer end (or different degrees of decrease in the pitch radius thereof toward the axial center), on each of the opposed sides of the cylindrical worm section 31a, as shown in FIG. 5. When the multiple tapered sections are provided on each of the opposed sides of the cylindrical worm section 31a, the number of effective teeth in engagement between the worm 31 and the worm wheel 23 can be further increased.

Specifically, as shown in FIG. 5, the tapered worm section 31b includes two tapered sections 31ba, 31bb, which are arranged one after the other in this order from the axial center side in the direction of the axis C, and the tapered worm section 31c includes two tapered sections 31ca, 31cb, which are arranged one after the other in this order from the axial center side in the direction of the axis C. A degree of increase in the pitch radius Pa at the pitch line P1 in the tapered section 31bb, which is further apart from the cylindrical worm section 31a in comparison to the tapered section 31ba, is set to be larger than that of the tapered section 31ba. A degree of increase in the pitch radius Pa at the pitch line P1 in the tapered section 31cb, which is further apart from the cylindrical worm section 31a in comparison to the tapered section 31ca, is set to be larger than that of the tapered section 31ca. As described above, each of the tapered worm sections 31b, 31c has the multiple tapered sections of different degrees of increase in the pitch radius thereof, and the addendum line of the worm tooth 34 is generally arcuate.

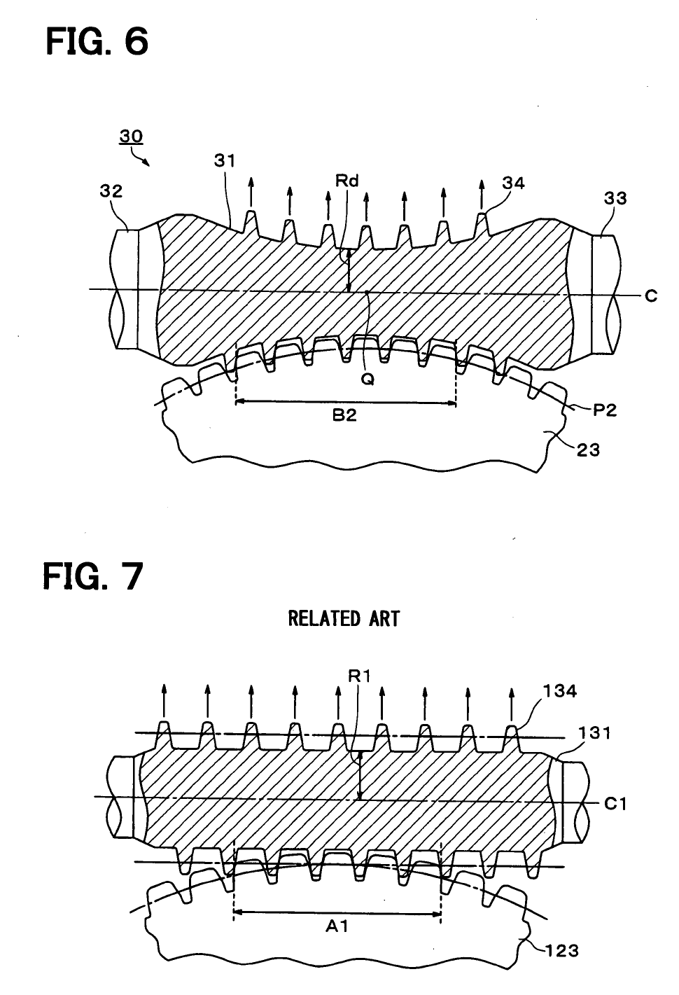

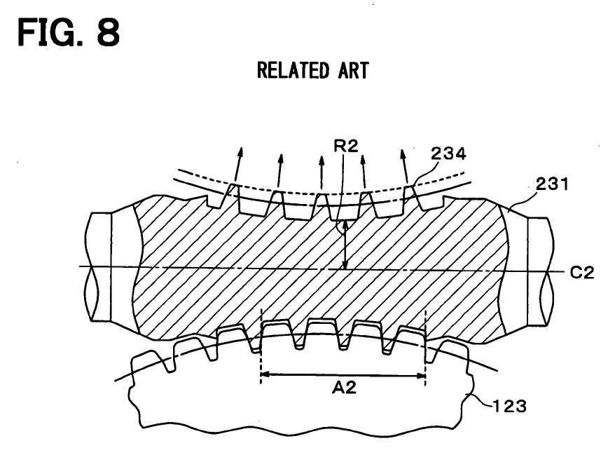

Furthermore, in the above embodiment, the worm 31 has the cylindrical worm section 31a and the tapered worm sections 31b, 31c. However, the present invention is not limited to this configuration. For example, the above configuration may be modified in a manner shown in FIG. 6. In the case of FIG. 6, the bottom land of the worm 31 is configured into an hourglass shape or an arcuate shape. That is, unlike the above embodiment, the deddendum radius Rd does not show a linear increase (a linear functional increase) in the direction away from the axial center Q along the axis C. Rather, the deddendum radius Rd shows a high-dimensional functional increase in the direction away from the axial center Q along the axis C in FIG. 6. Thus, a deddendum line (a bottom land line) of the worm 31 is generally arcuate. The tip directions are generally perpendicular to the axis C regardless a position of the worm tooth 34 along the length of the worm 31. Even with this configuration, the number of effective teeth in engagement between the worm 31 and the worm wheel 23 can be set to about six (see a range B2 in FIG. 6).

Furthermore, the worm 31 of the above embodiment is formed symmetrically about a throat (a part of the worm 31 where the pitch radius Pa is minimum along the length of the worm 31). However, the present invention is not limited to this configuration. For example, the worm 31 may be formed asymmetrically about the throat. For instance, only one of the tapered worm sections 31b, 31c may be formed continuously after the cylindrical worm section 31a while eliminating the other one of the tapered worm sections 31b, 31c.

Furthermore, in the above embodiment, the tapered worm sections 31b, 31c are connected together through the cylindrical worm section 31a. However, it is not absolutely necessary to form the cylindrical worm section 31a. For example, the tapered worm section 31b and the tapered worm section 31c may be connected at the throat of the worm 31 without forming the cylindrical worm section 31a.

Furthermore, in the above embodiment, the deddendum line of the respective tapered worm sections 31b, 31c is linear. However, the present invention is not limited to this. For example, the deddendum line of the respective tapered worm sections 31b, 31c may be curved.

In the above embodiment, the worm 31 is meshed with the worm wheel 23. However, the present invention is not limited to this. The worm 31 may be meshed with any other type of gear, such as a helical gear.

Additional advantages and modifications will readily occur to those skilled in the art. The invention in its broader terms is therefore not limited to the specific details, representative apparatus, and illustrative examples shown and described.

What is claimed is:

1. A worm comprising:
a bottom land; and
a helical worm tooth that protrudes from the bottom land and has a first side flank and a second side flank, which are opposed to each other in an axial direction of the worm, wherein:
a pitch radius of the worm tooth decreases toward an axial center of the worm at least in a part between one axial end of the worm and the axial center of the worm;
the first side flank is defined such that a first side normal line to the first side flank at a first side contact point between a pitch line of the worm tooth and the first side flank in a longitudinal cross section of the worm, is angled relative to a first contact side axial line, which is parallel to a central axis of the worm and extends through the first side contact point; and
a first side angle between the first side normal line and the first contact side axial line is generally constant throughout an entire axial extent of the worm.

2. The worm according to claim 1, wherein:
the second side flank is defined such that a second side normal line to the second side flank at a second side contact point between the pitch line of the worm tooth and the second side flank in the longitudinal cross section of the worm, is angled relative to a second contact side axial line, which is parallel to the central axis of the worm and extends through the second side contact point; and
a second side angle between the second side normal line and the second contact side axial line is generally constant throughout the entire axial extent of the worm.

3. The worm according to claim 2, wherein the first side angle and the second side angle are generally the same.

4. The worm according to claim 1, comprising a cylindrical worm section and a tapered worm section, wherein:
the pitch radius in the cylindrical worm section is generally constant throughout an entire axial extent of the cylindrical worm section; and
the tapered worm section includes the part between the one axial end of the worm and the axial center of the worm where the pitch radius of the helical tooth decreases toward the axial center.

5. The worm according to claim 4, wherein a degree of decrease in the pitch radius in the tapered worm section is generally constant throughout an entire axial extent of the tapered worm section.

6. The worm according to claim 4, wherein:
the tapered worm section is a first tapered worm section; and
the worm further comprises a second tapered worm section, which is formed between the other axial end of the worm and the axial center of the worm and in which the pitch radius decreases toward the axial center of the worm.

7. The worm according to claim 1, wherein a pressure angle at the first side flank and the pressure angle at the second side flank are generally the same throughout the entire axial extent of the worm.

8. The worm according to claim 1, wherein the first side angle is greater than 0 degree and is less than 14 degrees.

9. The worm according to claim 1, wherein the first side angle is about 10 degrees.

10. The worm according to claim 1, a degree of decrease in the pitch radius changes between the one axial end of the worm and the axial center of the worm.

11. A motor apparatus comprising:
a motor unit; and
a speed reducer that reduces a rotational speed of rotation transmitted from the motor unit and includes the worm of claim 1.
